(19) United States
(12) Patent Application Publication
(10) Pub. No.: US 2010/0322702 A1
(43) Pub. Date: Dec. 23, 2010

(54) Quick Coupling Assembly

(75) Inventor: Raunistö Yrjo, Hameenlinna (FI)

Correspondence Address: DILWORTH & BARRESE, LLP, 1000 WOODBURY ROAD, SUITE 405, WOODBURY, NY, 11797, US

(73) Assignee: KINSHOFER GMBH, Waakirchen (DE)

(21) Appl. No.: 12/635,753

(22) Filed: Dec. 11, 2009

(30) Foreign Application Priority Data
Dec. 11, 2008 (FI) 2008-0652

(51) Int. Cl. F16B 7/00

(52) U.S. Cl. 403/31

(57) ABSTRACT

A quick coupling assembly for fastening a working device to a working machine, wherein the working device comprises at least one pair of counter sleeves placed in the same axle line and at an adjusted distance from each other for pushing to the working machine coupled movable coupling pins (1a, 1b) into said sleeves wherein said coupling pins (1a, 1b) are placed in the working machine into a tube-like body (4), in which body said pins can be pushed in opposite directions at least partly out from said body (4) and pulled respectively back inside the body (4). In the inner surface of the tube-like body (4) of the assembly there are two separate counter sleeves (2a, 3a); (2b, 3b) in the points of both coupling pins (1a, 1b) which have cylindrical and smooth outer surfaces mounted, the positions of said sleeves are in the body (4) so arranged that in the coupling location where the pins (1a, 1b) are pushed out the inner surfaces of said sleeves are essentially of their contact length available in the contact with the outer surfaces of said pins.

The invention relates to a quick coupling assembly for fastening a working device to a working machine, wherein working device comprises at least one pair of counter sleeves placed in the same axle line and at an adjusted distance from each other for pushing to the working machine coupled movable coupling pins into said sleeves wherein said coupling pins are placed in the working machine into a tube-like body, in which body said pins can be pushed in opposite directions at least partly out from said body and pulled respectively back inside the body.

Earlier is known a quick coupling assembly for ex. from the publication WO 95/21969. In this publication an additional piece is presented, which has been fastened to the end of the boom in the working machine, said piece having tube-like body and pins which can be by means of hydraulic pressure pushed out from the ends of the body. The pins are pulled inside the body also by hydraulic pressure. At least one pin of the moving pins is a cylinder in that hydraulic system, by which system motions in/out for the pins are achieved.

From patent publications FI-108665 and U.S. Pat. No. 5,802,753 also solutions are known where the out coming pins are cylinders in that hydraulic system, by which system the pins are pushed out. The advantage obtained in these solutions is that the outer surfaces of the in/out moving pins are not needed to be sealed against hydraulic pressure.

In the quick coupling pin assembly the working device to be coupled to the working machine is a turnable device, wherein the pins are also articulation points allowing the device to be turned. Generally it is not allowed that the pin could rotate in the counter sleeve of the working device. Instead of that the pins are arranged to rotate in the sleeves of the body in the quick coupling assembly. When a bucket has been coupled to an excavator by means of this quick coupling assembly a great forces are directed to the pins. In this case also the pins are rotating when the bucket is turned. The earlier known pins and their counter sleeves are not reliable and long-lived enough. Due to those matters a new quick coupling assembly has been developed, by means of which assembly a durability of the movable and rotating pin and its counterparts is essentially improved.

Characteristic for the assembly according to this invention is that in the inner surface of the tube-like body of the assembly there are two separate counter sleeves in the points of both coupling pins which have cylindrical and smooth outer surfaces mounted, the positions of said sleeves are in the body so arranged that in the coupling location where the pins are pushed out the inner surfaces of said sleeves are essentially of their whole contact length available in the contact with the outer surfaces of said pins and that between the coupling pins the pushing out of the pins by means of hydraulic pressure as well as the pulling in of the pins by means of gas spring assembly are fitted.

The assembly according to the invention has advantage that by means of the separate counter sleeves fitted to pins in the assembly body sufficient bearing and gliding surface is achieved for said pins, the counter sleeves are in this case, being separate sleeves, easy to treat of their surfaces as hardening by boric-finishing, for ex. which is adding their durability when they receive high surface pressures caused by the hardened pins. The pins according to this invention are cylinders of relative thick wall thickness and no weakening portions are needed to make at their rear ends, as are needed to make in present known pins. In the invented assembly a counter sleeve has been separately formed for the front end of the pin and for the rear end of the pin inside the assembly body. The available maximum supporting length can be so achieved against the force which is bending the pin. The counter sleeves mounted in the both ends can be hardened by surface treatment, their distance maximized and their contact surfaces as well as contact surfaces of the pins are free of sealing grooves which will decrease bearing surface. By means of this assembly at least 30% more supporting area can be obtained compared with the present earlier known solutions at same pin diameter.

The need of seals and hoses in the hydraulic system has been minimized in the invention by mounting a gas spring system to operate inside the hollow pins and returning the pins back inside said body.

In the following the invention is closely described by referring to the drawings where

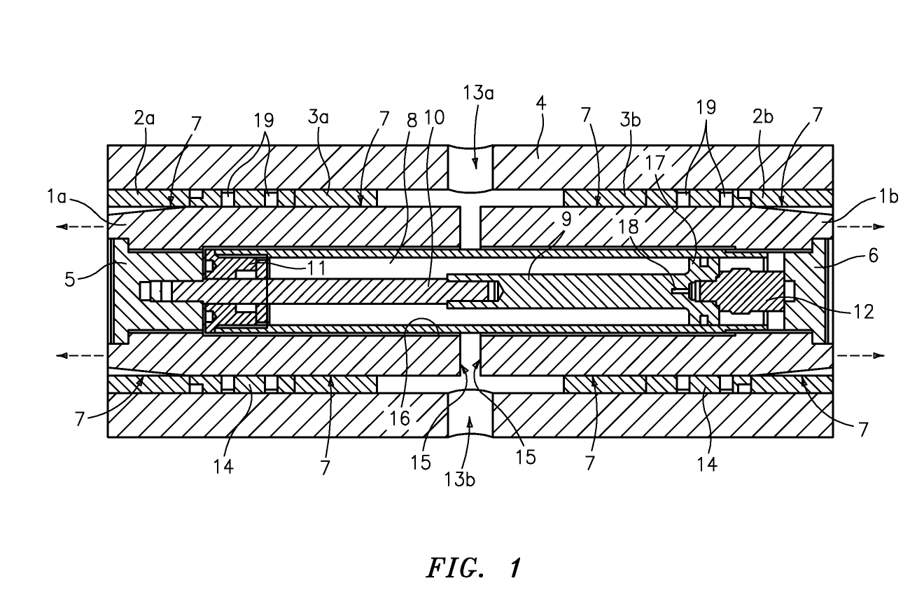

FIG. 1 shows first embodiment of a quick coupling system according to the invention seen as longitudinal section view.

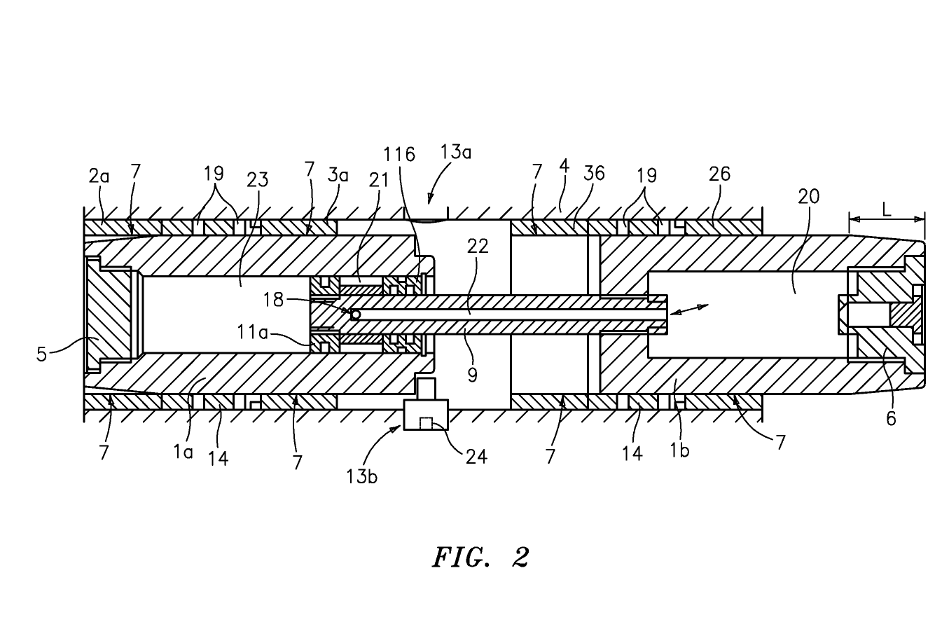

FIG. 2 shows second embodiment of a quick coupling system according to the invention seen as longitudinal section view.

In FIG. 1 there is presented as an example a quick coupling system which is meant to be fastened in the end of the boom of an excavator, said system comprising a tube-like body 4, inside which are mounted out from the body movable pins 1a and 1b. In the ends of the pins 1a, 1b conical portions are formed, which portions are pushed into the counter sleeves locating in the working device to be coupled. The counter sleeves are conical respectively. As their other parts the pins 1a and 1b are smooth cylinders of their outer surfaces and the pins are preferably at least of their outer surfaces hardened or of their body wholly hardened. The pins 1a, 1b are pushed out by means of hydraulic pressure by leading pressure via tube joint 13a into chamber space locating immediately after said joint 13a. Hydraulic pressure has an effect to the rear ends of the pins 1a, 1b and this pushes the pins out until the conical surfaces in their front ends hit the respective conical surfaces of the sleeves in the working device. After the sleeves 3a and 3b in the body 4 there are middle sleeves 14 mounted immobile in relation to said body, said sleeves 14 comprising needed seals 19 forming sealing towards the pins 1a, 1b as well as ring seals for sealing towards the body 4. The middle sleeves 14 and the counter sleeves 2a, 2b, 3a, 3b are fastened to the body firmly in order that hydraulic pressure does not push them out. For example the outer counter sleeves 2a, 2b can be coupled via threads to the body 4.

In this example a gas spring is fitted inside the pins, said spring returning the pins inwards when the pressure pushing out has been removed. The pressure chamber 8 of the gas spring locates inside the tube 16. The volume of the pressure chamber 8 is decreasing when the pins 1a, 1b are pushed out, because the movable piston 11 is gliding then on the axle 10 of the gas spring and its distance to the firm piston 17 on the axle is decreasing. The pressure in the gas spring chamber 8 returns the pins inside by expanding the gas chamber space 8. The axle 9, 10 is fastened by a thread to the end plug 5 of the pin 1a. The movable piston 11 is fastened to the gas spring tube 16 and said tube 16 is further fastened to the other pin 1b.

Pressure in the pressure chamber 8 of the gas spring can be raised and more gas added by opening the end plug 6 in the pin 1b and via with a thread jointed piece 12 additional gas can be led via a drilled hole 18 to the pressure chamber 8 of the gas spring.

Supporting of the pins 1a, 1b has been done by means of counter sleeves 2a, 2b 3a, 3b locating at a distance from each other, wherein they in best way support the pins at maximum distance. Especially the rear sleeves 3a, 3b are able to support the rear parts of the pins very well, because there in the rear parts of the pins are not placed any weakenings or sealing grooves. The counter sleeve 2a, 2b in the front locates just in the line of the end edge of the body. It is easy to treat the separate counter sleeves of their inside surfaces 7 by hardening or finished by boric and after that mount in the body 4. The position of the rear counter sleeves 3a, 3b in the body 4 is adjusted so that the rear ends 15 of the pins when pushing out are placed at the line of the rear ends of the sleeves 3a, 3b. The pins 1a, 1b rotate inside the body 4 in use. It is advantageous during working to keep on the pressure which is pushing the pins out as known from earlier solutions.

A centralizing plug 24 is mounted into the other treaded hole 13b in the body 4, said plug extending to a space between the pins 1a, 1b, which plug stops the pins as centralized in relation to the body when the pins are pulled inside the body. The pins are centralized when pushed out, by means of the length of the conical surfaces L. The pins can be pushed into counter holes of the working device only at the length L.

The embodiment of the FIG. 2 deviates from the solution of the FIG. 1 so that the pressure chamber 21 locates inside the pin 1a between the firm piston 11a and gliding piston 11b. In the FIG. 2 the pin 1b has been pushed out to a position which is twice compared with the normal pin position outwards. The presented position of the pin 1b is not possible in use. The pins 1a and 1b locate now eccentric in the body 4. In use they locate centralized both as pulled in and pushed out positions. The pin 1a is as pulled in position centralized by the plug 24. The space 20 inside the pin 1b is as container for pressurized gas and it is in connection with the pressure chamber 21 via drilled holes 22 and 18. The gas filling into the chamber 20 is carried out via the plug 6. The inside chamber of the pin 1a is not pressurized and it is in connection with open air for ex. via a little hole drilled in the plug 5.

1. A quick coupling assembly for fastening a working device to a working machine, wherein the working device comprises at least one pair of counter sleeves placed in the same axle line and at an adjusted distance from each other for pushing to the working machine coupled movable coupling pins (1a, 1b) into said sleeves wherein said coupling pins (1a, 1b) are placed in the working machine into a tube-like body (4), in which body said pins can be pushed in opposite directions at least partly out from said body (4) and pulled respectively back inside the body (4), characterized in that in the inner surface of the tube-like body (4) of the assembly there are two separate counter sleeves (2a, 3a); (2b, 3b) in the points of both coupling pins (1a, 1b) which have cylindrical and smooth outer surfaces mounted, the positions of said sleeves are in the body (4) so arranged that in the coupling location where the pins (1a, 1b) are pushed out the inner surfaces of said sleeves are essentially of their whole contact length available in the contact with the outer surfaces of said pins and that between the coupling pins (1a, 1b) the pushing out of the pins (1a, 1b) by means of hydraulic pressure as well as the pulling in of the pins (1a, 1b) by means of gas spring assembly (9-12, 16, 17);(9, 11, 18, 20, 21) are fitted.

2. A quick coupling assembly according to claim 1, characterized in that the gas spring assembly (9-12, 16, 17);(9, 11, 18, 20, 21) is fitted inside the coupling pins (1a, 1b) said pins being hollow pins.

3. A quick coupling assembly according to claim 1, characterized in that the gas spring assembly comprises a piston rod (9, 10);(9) and on it fitted at least one piston (11);(11b) gliding on said rod.

4. A quick coupling assembly according to claim 1, characterized in that the counter sleeves locate at a distance from each other and one (2a, 2b) of the counter sleeves is fitted inside the body (4) extending inwards from the edge line of the body (4) and the other sleeve (3a, 3) so that in the pin (1a, 1b) position pushed out the rear end (15) of the pin locates essentially in the line of the rear end of the counter sleeve (3a, 3b).

5. A quick coupling assembly according to claim 1, characterized in that the coupling pins (1a, 1b) are from their outer surfaces or wholly hardened and the counter sleeves (2a, 3a);(2b, 3b) are finished by hardening from their inner surfaces.
